(19) United States
(12) Patent Application Publication
(10) Pub. No.: US 2007/0040023 A1
(43) Pub. Date: Feb. 22, 2007

(54) Method and apparatus for protecting self service terminals from fraud and tampering

(76) Inventors: Aj Ruggirello, Clarkston, MI (US); Gary Noe, Flat Rock, MI (US); Michael Blessing, Canton, MI (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/207,760

(22) Filed: Aug. 22, 2005

(51) Int. Cl. G06K 5/00; G06F 7/08; G06K 7/00

(52) U.S. Cl. 235/382; 235/381; 235/439

(57) ABSTRACT

An antifraud device for use with a self service terminal having a fascia formed with an entry slot accessed by a bank card and a keypad has a control system for disabling the terminal in the event of tampering. A cover overlying the entry slot has an opening aligned with the entry slot of the card reader. The cover has a selected thickness thereby allowing the card to pass through it without allowing additional travel should something capable of reading the card be placed over the cove the entry slot. The cover has a breakaway contact adapted to sense unauthorized removal. A detector is provided to sense the presence of an unauthorized object proximate to the entry slot or keypad or both. A control system responsive to the breakaway contact and detector disables the terminal if the cover is removed or if the entry slot is covered by an unauthorized reader.

### BACKGROUND OF THE INVENTION

The invention is directed to a method and apparatus for preventing fraud and tampering with self service terminals of the type having an access slot for a bank card. The invention is particularly for preventing a scam known as skimming, which is the unauthorized collection of card and personal user information during an otherwise proper transaction.

Self service terminals allow consumers to access funds at remote locations such as at automated teller machines (ATM), or to make payment at point of sale locations. These remote terminals are usually equpped with devices to sense tampering, and to prevent certain types of fraud. For example, ATM machines have seismic sensors to detect vibrations if the machine is physically moved or disturbed. These machines have programs to disable the transaction if multiple attempts fail to properly verify a user's password. These features are generally designed to protect the contents of the machine, i.e. cash, or to protect the device itslef.

While these features have generally been helpful in reducing physical attacks on the equipment, they do not prevent all forms of fraud and tampering. For example, over the past few years, individuals have been successful in illegally retrieving the information stored on a users bank card. The technique, known as skimming, allows an idividual to collect information sufficient to create a useable, but illegal, ATM or access card. Once an illegal card is created, it can not only be used to access the funds in an ATM, but it can be used to purchase goods and services at the expense of the cardholder or the institution issuing the card. Although uers are usually protected from financial loss by the bank or terminal operator, the losses, none the less have a significant impact on the businesses and customers who rely on a secure system to facilitate remote and self service transactions. There is a need therefore to reduce the occurrence of these losses.

One common method to facilitate skimming is when thieves install an illegal card reader over the existing card reader slot in the terminal. When the customer inserts the card, it is passed through the illegal reader and the data stored on the magnetic strip on the card is captured. In many instances the thieves attach an inconspicuous miniature television camera to the terminal and video tape or photograph a user entering his or her personal identification number (PIN) on the key pad. Some thieves use an illegal key pad disposed atop the keypad on the terminal to capture PIN data. The information may be transmitted by the illegal card reader and key pad.

After the illegally placed devices have been attached to the terminal for an hour or so, the thieves will go back to the machine and recover the devices. The equipment may be used at any location where it can be employed without being detected.

The information may be recorded in the illegal device or it may be transmitted to a remote location for recordation. However this is accomplished, once the information is collected, the criminal now has the information recorded on the mangentic strip from the bank card and the PIN information. The scam is designed to allow the illegal equipment to serriptisiously collect the information without physically interfering with the transaction being conducted by the unsuspecting coustomer. So the theft of the information goes unnoticed until the thieves use the information to create and use a bogus card at sales, banking and service establishments.

There is therefore a need for detecting these fraudulent activities and for rendering remote terminals resistant to tampering of the sort described. In the event that tampering is discovered, the terminal may be promptly disabled thereby reducing or eliminating the illegal collection of information at that location.

### SUMMARY OF THE INVENTION

The invention is based on the discovery that a self service terminal having an access device may be made resistant to tampering by employing a control system for monitoring the access device and interrupting the transaction underway in order to thwart illegal collection of card and PIN information.

In a particular embodiment the device to be protected is a self service terminal having a power supply and a fascia formed with a card reader having an entry slot accessed by a bank card and a keypad. A control system in operative relation with the power supply interrups the power supplied to the terminal in response to tampering. A sensor may also be employed to produce an alarm indicative of tampering with the entry slot, the keypad or both. As these terminals are routinely monitored, interruption of power or an alarm will alert maintenance and security personnel who will then dispatch appropriate personnel to the location in order to investigate the interruption and service the terminal. The terminal is equpped with a selectable reset, operable by an authorized person, to reset the power after an incident.

In a patricular embodiment the invention comprises a cover for the access slot of the motorized card reader. The cover is secured to the fascia and overlies the slot for preventing attachment of an unauthorized card reader. The cover has a surface texture and shape adapted to discourage attachemnt of an overlying card reader. The thickness of the cover is also sufficient to allow the card to pass through it without allowing additional travel should an illegal device capable of reading the card be placed over the cover. Thus, if an illegal card reader is placed over the slot, once the card is inserted it will be captured by the card reader. When the transaction is completed, the card will be returned or presented to the customer. However, because the overlying device is in the way, the customer cannont retrieve the card, which after a given time period is drawn back into the machine.

A breakaway contact is secured to the cover which extends through the fascia and is coupled to the control system. If the thief notices the cover and tries to remove it forceably, the contact becomes an open circuit, thereby disabling the terminal and optionally raising an alarm.

In an other embodiment, an infrared sensor located proximate to the access slot, key pad or both is operative to detect if an illegal device has been placed over the access slot or keyboard. The sensor, in response to tampering, disables the terminal and raises an alarm which summons security and maintenance personnel. The sensor comprises an IR transmitter for directing infrared radiation in an optical path, and an IR receiver responsive to the radiation. If something is located in the optical path, radiation is reflected towards the receiver which produces an output. A timer coupled to the receiver, times the duration of the output and disables the terminal and optionally initiates an alarm if the duration is longer than a selected time. The timer resets itself each time the reflected radiation is interrupted so that random signals which occur normally do not set off the alarm unintentionally. In other words, the condition indicative of tampering must endure for a time sufficient to avoid false alarms.

### BRIEF DESCRIPTION OF THE DRAWINGS

FIG. 1 is an illustration of a self service terminal employing an anti fraud and anti tampering system according to the invention.

FIG. 2 is a perspective view of a card guard for protecting the card entry slot of a self service terminal.

FIG. 2A is a sectional view of the card guard shown in FIG. 2 taken along line 2A thereof.

FIG. 2B is sectional view of the card guard shown in FIG. 2 taken along line 2B thereof.

FIG. 2C is a detail of the surface texture of the protrusions on the card guard.

FIG. 3 is a rear elevation of the card guard shown in FIG. 2.

FIG. 4 is a fragmentary sectional view of the card guard shown in FIG. 3, taken along line 4-4 thereof and showing a detail of the break away connection.

FIG. 5 is an illustration of the optical detector.

FIG. 6 is a schematic illustration of the operating optical detector.

FIG. 7 is a schematic diagram of a control circuit employed in a self service terminal.

### DESCRIPTION OF THE INVENTION

The invention comprises an anti fraud and anti tampering apparatus for protecting a self service terminal 10 and users threof against fraud and tampering. In particular, the invention is for preventing a scam known as ‘skimming’ wherein a thief employing an illegal card reader serriptisciously obtains card information from an unsuspecting customer, which information allows the thief to create a useable but unauthorized bank card.

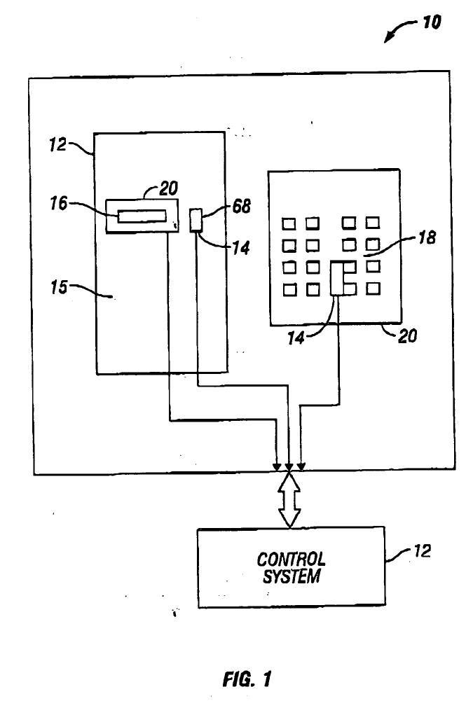

The invention is generally illustrated in FIG. 1 wherein the terminal 10 to be monitored and protected is coupled to a control system 12 adapted to disable the terminal in the event of tampering. One or more sensors 14 may be employed which are adapted to signal the control system to disable the terminal and optionally to provide an alarm signal to alert security and maintenance personnel of the incident. If tampering is detected, any transaction in progress is terminated.

The terminal 10, which is schematically illustrated, is exemplary of many different known devices. Such terminals are generally equipped with a card reader 12 mounted behind a fascia 15. The card reader 12 has a card entry slot 16 formed in an opening in the fascia as illustrated. The card reader recieves the card in the entry slot and draws it into the reader for the duration of the transaction. The terminal will also have a keypad 18 or data entry device whereby the user enters a personal identification number (PIN) or other information as required in using such devices.

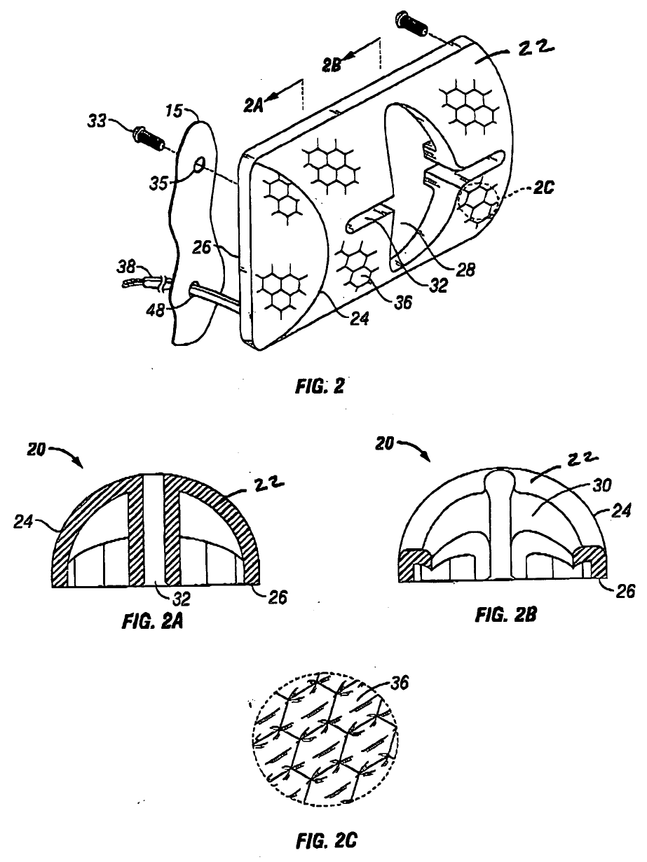

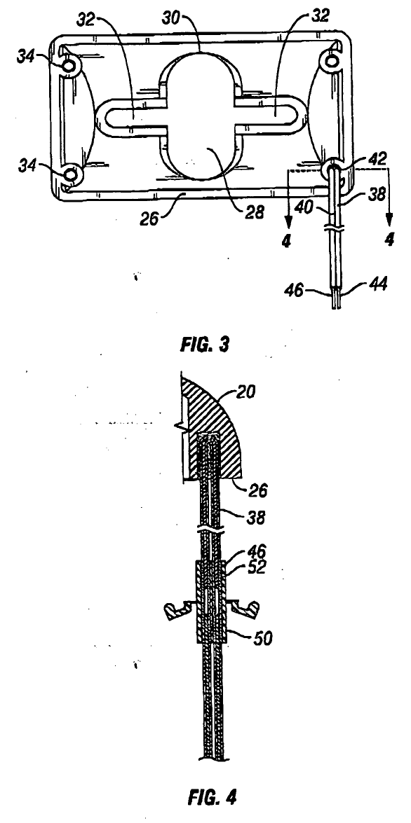

According to one aspect of the invention, it is desirable to prevent or frustrate skimming by preventing the use of illegal card readers. FIGS. 2-4 illustrate a device or cover 20 for such purpose. The cover 20 comprises a molded body 22 formed with a rounded outer face 24 and a rear face 26 that confronts the fascia. The cover 20 has an elongated through opening 28 having a central oval portion 30 and outboard slotted portions 32. The cover 20 is adapted to be mounted onto the fascia by screws 33 passing through openings 35 in the fascia and secured in treaded bosses 34 formed in the rear surface 26 of the cover 20. When mounted on the fascia 14, the opening 28 is alligned with the entry slot 16 as illustrated.

The rounded outer face 24 of the cover is formed with molded protrusions 36 which resemble spherical indentations on the surface (FIG. 2C). The rounded shape of the cover and the indentations reduce the stable adhesive surface area of the cover so that if thieves try to install a card reader over the entry slot 16 it will not adhere well, and if it adheres it will tend to be unstable or wobbly, thereby interfering with the scam.

The cover is equpped with an insultated wire loop 38 which has a proximal end 40 secured in an opening 42 in the rear surface as shown, and a distall end 44 extending away from the cover and having a portion of the insulation removed thereby exposing metal conductive contact portions 46. The loop is bent on itself at its proximate end 42 and forms a continuous conductor between the contact portions. The distall end 44 of the loop extends through an opening 48 in the fascia 15 and is coupled to control system by means of a break-away connector 50 having contacts 52 engaging the conductors 46. If a thief tries to remove the cover 20, doing so will cause the the loop 38 to be pulled away from the connector 50 thereby open circuiting the connection with the control system 12. When the loop is open circuited, the control system 12 disables the terminal and optionally produces an alarm.

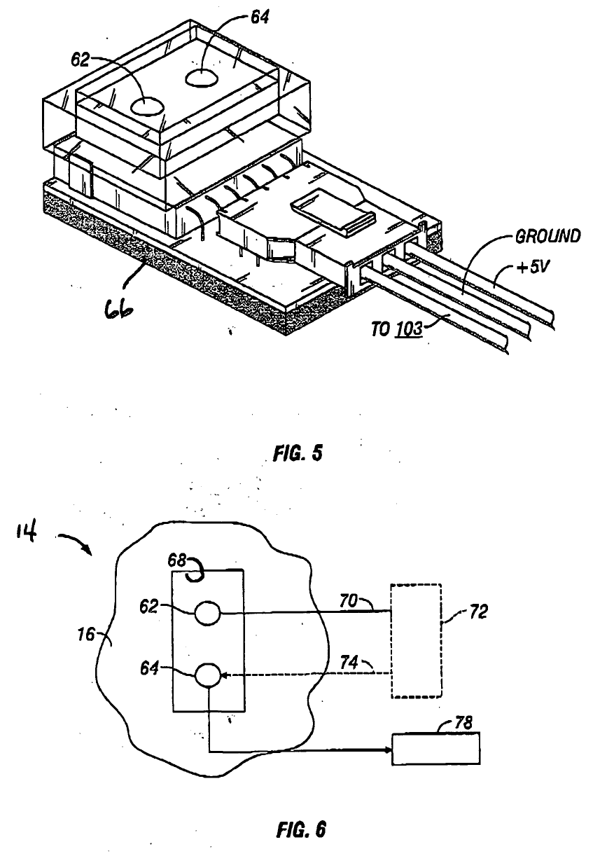

The invention also may employ an optical sensor for detecting conditions which indicate tampering as well. For example, FIGS. 1, 5 and 6, illustrate an optical sensor 14 equipped with an infra red (IR) transmitter 62, e.g. a light emmitting diode, and an infra red sensor or receiver 64 mounted on a base 66. The sensor is mounted in an opening 68 in the fascia 15. The transmitter produces, when energized, an IR output beam 70 which is directed outwardly of the fascia. If the transmitter is blocked or covered by an unauthorized device such as a card reader 72, transmitted light strikes the device and some of the light 74 is reflected towards the receiver. This reflected light 74 is detected by the receiver which produces a signal input to a timer 78 in the control system.

The timer is set for some period that is indicative of tampering. If the sensor detects light for longer than the allotted time, the terminal is disabled and an alarm is raised. Because the detector is sensitive to reflected light from the transmitter, the timer allows for spurious signals to be detected without immediately disabling the terminal. For example as the user interacts with the terminal, there may be reflected light sensed. However, it is only when the duration of the detected light exceeds the limit set in the timer that the terminal is disabled and an alarm is initiatiated.

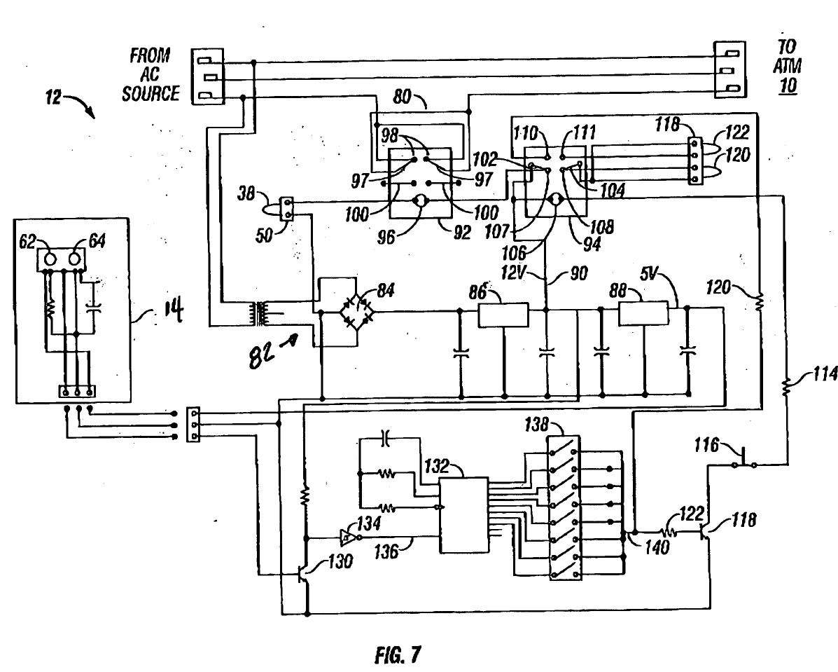

FIG. 7 is a schematic illustration of the control system according to the invention. As illustrated, the control system 12 is coupled to a power circuit 80 for carrying AC power from an AC source (not shown) which energizes the ATM 10. Under the conditions illustrated in FIG. 7, the terminal 10 is energized and operable. The terminal is powered by the AC source 80 and the control system 12 is standing by to interrupt the power in the event of tampering.

The control system 12 includes a DC power supply 82 coupled to the AC source 80. The power supply 82 is equipped with a full wave rectifier 84 which feeds voltage regulators 86 and 88. Regulator 86 provides a 12 volt output for relay circuits on line 90, and regulator 88 provides a 5 volt output for the electronic circuits, both of which are described below.

The control system employs a normally energized power relay 92 and a normally deenergized device or alarm relay 94. Power 92 relay has a coil 96 for actuating moveable contacts 97 and fixed contacts 98. Normally energized power relay 92 maintain contacts 98 closed, completing the AC power circuit 80 to the terminal 10.

The alarm relay 94 has normally closed moveable contacts 102 and 104; a contact actuating coil 106, normally closed fixed contacts 107 and 108, and normally open fixed contacts 110 and 111. The power relay 92 is energized from the 12 volt line through normally closed front contacts 102 and 107, coil 94, loop 38, break away connector 50 and rectifier 84.

When the loop 38 is open circuited as described above, indicating that the cover has been forceably removed, the coil circuit 96 of the power relay 92 is open, deenergizing the relay and thereby open circuiting the AC power for the termial. Once disabled in this way, the terminal remains off until the loop 38 is reinstalled by maintenance personnel.

Power relay 92 may also be deenergized when the alarm relay 94 is activated if tampering is sensed by optical sensor 60. As illustrated, the alarm relay 94 is powered from the 12 volt source through the coil 106, resistor 114, normally closed reset switch 116, and transistor or electronic switch 118 to ground. The switch 118 is biased to be normally open circuit, or non conducting. Thus the alarm relay 94 is normally deenergized.

The switch 118 is caused to conduct in the event of an alarm condition, described below, and when the switch 118 conducts, power is applied to the coil 106 causing the alarm relay 94 to energize. As a result, movable contacts 102 open the front contact 107 thereby opening the circuit for power relay 92, and thus disabling the terminal. When the back contact 110 closes the circut for the alarm relay 94 is completed and is held energized via stick circuit incluidng resistor 120 and base resistor 122 feeding the base of switch 118. The alarm relay 94 is deenergized by depressing the reset switch and opening the circuit to coil 106. In this way, the alarm relay is held energized by the stick circuit until the normally closed reset switch 116 is opened by manual actuation.

The control circuit includes an input for the optical sensor 60 illustrated in FIG. 1. The sensor detects the presence of an unauthorized object proximate to the entry slot and includes transmitter 62 and receiver 64 mounted on a support secured in an opening in the fascia. The sensor 60 is normally conducting and carries a 5 volt signal from the power supply 88 to the base circuit of a normally conducting transistor switch 130 which supplies power to a timer circuit 132, which in turn controls the switch 118 in the power circuit of the alarm relay 94. If the switch 130 is off or non conducting for a selected interval of time indicative of tampering, the alarm relay 94 is energized switch 118 as hereinabove described. The alarm relay 94, once energized, must be manually reset by security and maintenance personnel. The sensor may be an infra red sensor as described, but may also be another type of device adapted to sense the presence of an unauthorized object near the slot of the terminal.

As noted, the switch 130 is normally conducting and threby produces a low output feeding inverter 134. The inverter, in turn, places a high on an input to timer circuit 132. A selector switch 138 for the timer is adapted to selectively control the timer output 140 feeding the base circuit of switch 118 in alarm relay circuit. The selector switch 138 may be manually set for a desired time interval, and should the timer input remain high for such period, the timer produces an output to cause the normally non conducting switch 118 to conduct and threby energize the alarm relay 94. The duration is selected so as to provide a positive indication of tampering, i.e. normal use of the machine may cause the detector to sense the presence of an object near the slot during normal useage. However, if the sensor momentarily senses the presence of an object, the timer will reset itself each time the reflected signal is interrupted. The alarm will not be raised unless and until the timer input has a sufficient duration as selected by the terminal operator. Once the realy conducts, maintenance personnel must manually reset the alarm relay to return the terminal to service.

The invention contemplates a method whereby the cover and optical detector may be employed either alone or in combination to disable the terminal in the event of tampering and threby avert fraud against users of the equipment.

While there has been provided what is an exemplary embodiment of the invention, it will be apparent to those of skill in the art that various changes and modifications may be made therein, and it is intended in appended claims to cover such changes and modifications as fall within the scope of the invention.

What is claimed is:

1. An antifraud device for disabling a self service terminal accessed by an access device comprising:
a control system having an alarm input and being in operative relation with the terminal, said control system for monitoring the access device and interrupting power supplied to the to the terminal in response to tampering with the access device.

2. An antifraud device for use with a self service terminal having a power supply and a fascia formed with and entry slot accessed by a bank card comprising:
a control system having an alarm input and being in operative relation with the power supply for the terminal, said power supply operative for interrupting power supplied to the terminal in response to tampering with the entry slot;
a sensor for producing an alarm indicative of tampering with the entry slot;
and a selectable reset for the control system for resetting power after an alarm.

3. The anti fraud device of claim 2 further comprising a cover for the slot secured to the fascia for preventing attachment to the fascia of an unauthorized card reader; and
a breakaway contact secured to the cover extending through the fascia and being coupled to the control system, said contact being open circuit if the cover is removed.

4. The anti-fraud device of claim 2 wherein the cover has a surface having indentations for preventing adhesion of unauthorized devices to the cover.

5. The antifraud device of claim 1 further comprising an electromagnetic sensor in wireless communication with the access slot for detecting external interaction with the slot, and for providing an alarm when the interaction exceeds a selected time interval indicative of tampering.

6. The antifraud device of claim 3 where in the sensor comprises an IR transmitter for producing source radiation in an optical path; and an IR receiver responsive to source radiation reflected thereat resulting from the presence of an object in the optical path.

7. The antifraud device of claim 2 wherein the control system includes a timer for timing the duration of the reflected radiation and for initiating an alarm if the reflected radiation has a duration longer than a selected time indicative of tampering.

8. The antifraud device of claim 7 wherein the timer includes a clock for restarting the timer each time the reflected radiation is interrupted before initiation of the alarm indicative of tampering.

9. The antifraud device of claim 2 wherein the terminal has a keypad further comprising a keypad sensor for producing an alarm indicative of tampering with the keypad.

10. An antifraud device for use with a self service terminal having a fascia formed with an entry slot accessed by a bank card and a keypad comprising:
a control system for disabling the terminal in the event of tampering;
a detector for at least one of the entry slot and keypad being coupled to the control system for sensing interaction with each of the access slot and keypad, each said detector being responsive to detect tampering;
a cover overlying the entry slot, the cover having a slot aligned with the entry slot of the card reader, said cover having a selected thickness thereby allowing the card to pass through it without allowing additional travel should something capable of reading the card be placed over the cover;
and a breakaway wire contact secured to the cover being disposed behind the fascia, said contact being severed when the cover is removed.

11. An antifraud device for use with a self service terminal having a fascia formed with an entry slot comprising:
a cover overlaying the entry slot, the cover having a slot aligned with the entry slot of the card reader, said cover having a selected thickness thereby allowing the card to pass through it without allowing additional travel should something capable of reading the card be placed over the cover;
and a breakaway wire contact secured to the cover being disposed behind the fascia, said contact being severed when the cover is removed for disabling the terminal.

12. An antifraud device for use with a self service terminal having a fascia formed with an entry slot comprising:
an infra red source for producing radiation;
a receiver responsive to reflected radiation resulting from the presence of an unauthorized object proximate the entry slot for producing an output signal indicative of tampering, and
a timer responsive to the receiver for producing a signal indicative of tampering for disabling the terminal if the signal has a selected duration.

13. A method for detecting fraud and tampering with a self service terminal accessed by a bank card via an entry slot comprising the steps of:
placing a cover overlying the entry slot, the cover having a slot aligned with the entry slot of the card reader, said cover having a selected thickness thereby allowing the card to pass through it;
equipping the cover with a breakaway wire contact;
locating the contact behind the fascia, and
severing the contact when the cover is removed for disabling the terminal.

14. A method for detecting fraud and tampering with a self service terminal accessed by a bank card via an entry slot comprising the steps of:
providing an infra red source for producing radiation;
providing an receiver responsive to radiation reflected thereat resulting from the presence of an authorized object proximate the entry slot for producing an output signal;
timing the signal indicative of tampering; and
disabling the terminal if the signal has a selected duration indicative of tampering.
